(19) United States
(12) Patent Application Publication
(10) Pub. No.: US 2023/0219053 A1
(43) Pub. Date: Jul. 13, 2023

(54) PRESSED SILICON CARBIDE CERAMIC (SIC) FLUIDIC MODULES WITH INTEGRATED HEAT EXCHANGE

(71) Applicant: CORNING INCORPORATED, CORNING, NY (US)

(72) Inventors: Alexander Lee Cuno, Sayre, PA (US); Howen Lim, Great Neck, NY (US); James Scott Sutherland, Painted Post, NY (US)

(21) Appl. No.: 18/010,955

(22) PCT Filed: Jun. 24, 2021
(86) PCT No.: PCT/US2021/038841

§ 371 Date: Dec. 16, 2022

Related U.S. Application Data
(60) Provisional application No. 63/046,676, filed on Jun. 30, 2020.
(60) Provisional application No. 63/065,072, filed on Aug. 13, 2020.

(51) Int. Cl. B01J 19/24; B01J 19/00; C04B 35/575; C04B 35/628; C04B 35/645

(52) U.S. Cl. CPC B01J 19/2485; B01J 19/0013; B01J 19/0093; C04B 35/575; C04B 35/628; C04B 35/645; B01J 2219/2411; B01J 2219/2438; B01J 2219/2403; B01J 2219/2446; B01J 2219/00824; B01J 2219/00873; B01J 2219/0086; C04B 2235/3826; C04B 2235/6028; C04B 2235/77

(57) ABSTRACT

A silicon carbide flow reactor fluidic module comprises a monolithic closed-porosity silicon carbide body, a tortuous fluid passage extending through the silicon carbide body, the tortuous fluid passage having an interior surface, and one or more thermal control fluid passages also extending through the silicon carbide body, the interior surface having a surface roughness of less than 10 μm Ra. A process for forming such modules is also disclosed.

### CROSS-REFERENCE TO RELATED APPLICATIONS

This application claims the benefit of priority under 35 U.S.C. § 119 of U.S. Provisional Application No. 63/046,676, filed Jun. 30, 2020 and also claims the benefit of priority under 35 U.S.C. § 119 of U.S. Provisional Application No. 63/065,072, filed Aug. 13, 2020, the content of each of which is incorporated herein by reference in its entirety.

### FIELD OF THE DISCLOSURE

The disclosure relates to methods of fabrication of flow reactor fluidic modules comprising ceramic, and more particularly to methods fabrication of low-porosity monolithic silicon carbide ceramic flow reactor fluidic modules with smooth-surfaced tortuous internal passages extending through the modules, and to the fluidic modules themselves.

### BACKGROUND

Silicon carbide ceramic (SiC) is a desirable material for fluidic modules for flow chemistry production and/or laboratory work. SiC has relatively high thermal conductivity, useful in performing and controlling endothermic or exothermic reactions. SiC has good physical durability and thermal shock resistance. SiC also possesses extremely good chemical resistance. But these properties, combined with high hardness and abrasiveness, make the practical production of SiC fluidic modules challenging.

Flow reactors formed of silicon carbide ceramic are often prepared via a sandwich assembly approach. Green ceramic bodies are pressed into slabs and then shaped, generally on one major surface, using CNC machining, molding, or pressing operations, or the like. After green body firing, two fired slabs are joined together, shaped surfaces facing each other, with or without an intermediate joining layer of ceramic material. In a second firing step the joint is fused (and/or the joining layer densities) to produce a body with one or more internal channels.

The sandwich assembly joining approach can introduce problems in the fabricated fluidic modules. In modules joined having an intermediate layer, porous interfaces may form at the joining layer. These may trap liquids causing potential for contamination/difficulty cleaning and for mechanical failure (such as by freezing in the pores). Modules joined without intermediate joining layers have required or resulted in inclusion of relatively coarse ceramic grains, producing internal channel surfaces with an undesirable level of roughness.

In another approach, multiple layers of green-state SiC sheets can be produced and cut to shapes required to build up a fluidic module slice-by-slice. Such an approach tends to produces small step-like structures in curved profiles of internal passages. For emptying and cleaning/purging of fluidic modules, the wall profiles of internal passages are desirably smooth and free from small step-like structures.

Accordingly, there is a need for SiC fluidic modules and methods of fabricating SiC fluidic modules with internal passages having improved internal-passage surface properties, specifically: low porosity generally, or no significant porous interfaces at a seal location, low surface roughness, and smooth wall profiles.

### SUMMARY OF THE DISCLOSURE

According to some aspects of the present disclosure, a monolithic substantially closed-porosity silicon carbide fluidic module is provided, having a tortuous fluid passage extending through the module, the tortuous fluid passage having an interior surface, the interior surface having a surface roughness in the range of from 0.1 to 80 μm Ra.

According to some additional aspects of the present disclosure, a process for forming a monolithic substantially closed-porosity silicon carbide fluidic module is provided, the process comprising positioning a positive fluid passage mold within a volume of silicon carbide powder, the powder coated with a binder; pressing the volume of silicon carbide powder with the mold inside to form a pressed body; heating the pressed body to remove the mold; and sintering the pressed body to form a monolithic silicon carbide fluidic module having a tortuous fluid passage extending therethrough.

The module of the present disclosure has very low open porosity (as low as 0.1% or less) and low roughness of the tortuous passage interior surface (as low as 0.1 μm Ra). This provides a fluidic module resistant to infiltration by fluids, easily cleanable, with low pressure drop during use. During use, fluidic boundary layers near the smooth interior wall surface are thin relative to boundary layers resulting from rougher surfaces, providing better mixing and heat exchange performance.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a diagrammatic plan view outline of a fluidic passage of a type useful in flow reactor fluidic modules showing certain features of the fluidic passage;

FIG. 2 is a perspective external view of an embodiment of a fluidic module of the present disclosure;

FIG. 3 is a diagrammatic cross-sectional view of an embodiment of a fluidic module of the present disclosure;

FIG. 4 is a flow chart showing some embodiments of a method for producing a fluidic module of the present disclosure;

FIG. 5 is a step-wise series of cross-sectional representations of some embodiments of the method(s) described in FIG. 4;

FIG. 6 is a graph illustrating compression release curves useful in practicing the methods of the present disclosure;

FIG. 7 is a cross-sectional diagrammatic view of another embodiment of a fluidic module of the present disclosure;

FIGS. 8A and 8B are diagrammatic views of additional embodiments of fluidic modules of the present disclosure;

FIGS. 9A and 9B are diagrammatic views of yet more additional embodiments of fluidic modules of the present disclosure;

FIG. 10 is a digital image showing internal passage molds according to an embodiment of the present disclosure; and

FIGS. 11A and 11B are digital images showing internal passage molds according to two more embodiments of the present disclosure.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, a “tortuous” passage refers to a passage having no line of sight directly through the passage and with the central path of the passage tracing more than one radius of curvature. Typical machining-based forming techniques are generally inadequate to form such a passage.

As used herein a “monolithic” silicon carbide structure of course does not imply zero inhomogeneities in the ceramic structure at all scales. A “monolithic” silicon carbide fluidic module, as the term “monolithic” is defined herein, refers to a silicon carbide fluidic module, with a tortuous passage extending therethrough, in which no inhomogeneities of the ceramic structure are present of sufficient size to extend from an external surface of the fluidic module to a surface of the tortuous passage.

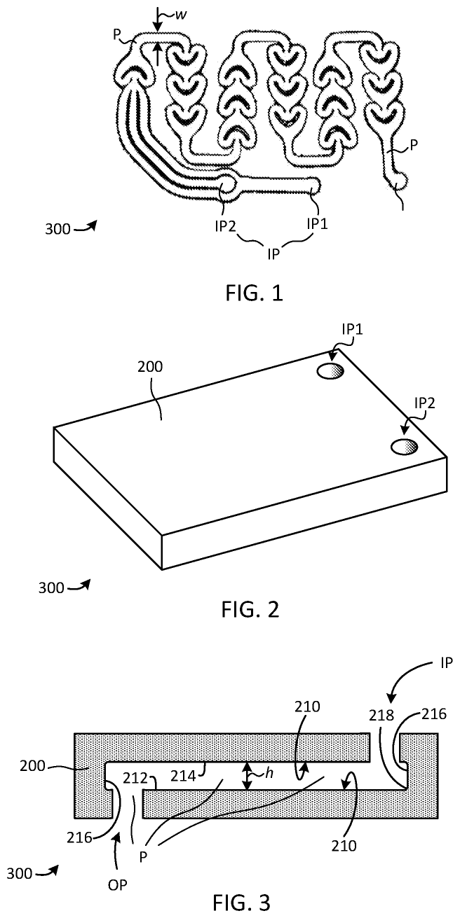

With reference to FIGS. 1-3, a silicon carbide flow reactor fluidic module 300 is disclosed. The module 300 comprises a monolithic closed-porosity silicon carbide body 200 and a tortuous fluid passage P extending through the silicon carbide body 200. The tortuous fluid passage P has an interior surface 210. The interior surface 210 has a surface roughness in the range of from 0.1 to 80 μm Ra, or 0.1 to 50, 0.1 to 40, 0.1 to 30, 0.1 to 20, 0.1 to 10, 0.1 to 5, or even 0.1 to 1μm Ra, lower than silicon carbide fluidic modules have previously achieved.

According to further embodiments, the silicon carbide body 200 of the fluidic module 300 has a density of at least 95% of a theoretical maximum density of silicon carbide, or even of at least 96, 97, 98, or 99% of theoretical maximum density.

According to further embodiments, the silicon carbide body 200 of the fluidic module 300 has an open porosity of less than 1%, or even of less than 0.5%, 0.4%, 0.2% or 0.1%.

According to still further embodiments, the silicon carbide body 200 of the module 300 has an internal pressure resistance under pressurized water testing of at least 50 Bar, or even at least 100 Bar, or 150 Bar.

The tortuous fluid passage P, according to embodiments, comprises a floor 212 and a ceiling 214 separated by a height h and two opposing sidewalls 216 joining the floor 212 and the ceiling 214. The sidewalls are separated by a width w (FIG. 1) measured perpendicular to the height h and the direction along the passage (corresponding to the predominant flow direction when in use). Further, width w is measured at a position corresponding to one-half of the height h. According to embodiments, the height h of the tortuous fluid passage is in the range of from 0.1 to 20 mm, or from 0.2 to 15, or 0.3 to 12 mm.

According to embodiments, the interior surface 210 of the fluidic passage P where the sidewalls 216 meet the floor 212 has a radius curvature (at reference 218) of greater than or equal to 0.1 mm, or greater than or equal to 0.3, or even 0.6 mm

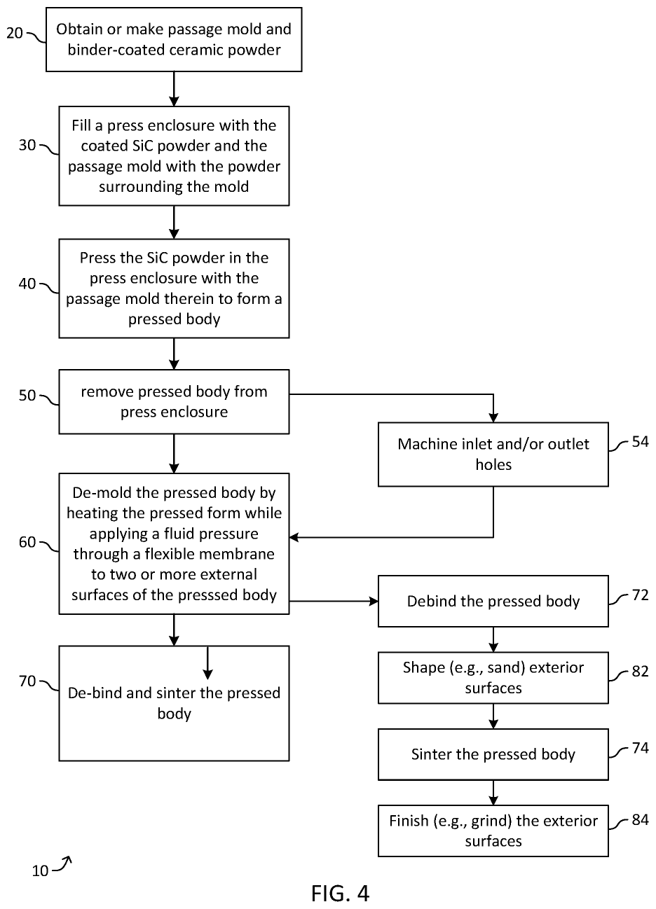

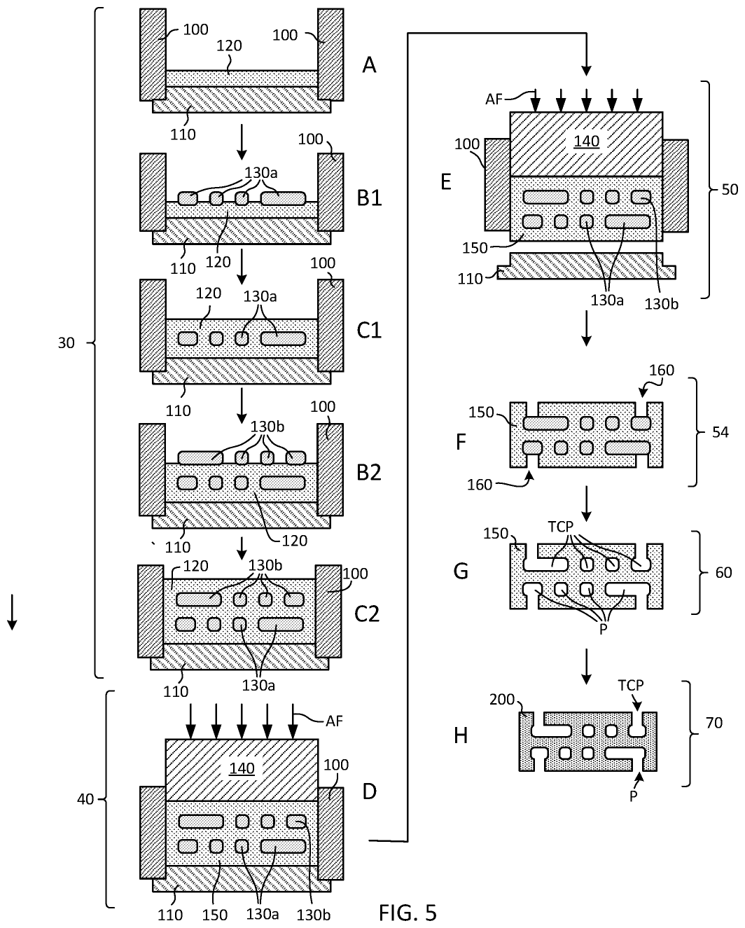

With reference to FIGS. 4 and 5, according to embodiments, a process for forming a silicon carbide module for a flow reactor having one or more of these or other desirable properties can include the step 20 of obtaining or making a passage mold and a binder-coated SiC powder (such powders are commercially available from various suppliers). The passage mold may be obtained by molding, machining, 3D printing, or other suitable forming techniques or combinations thereof The material of the passage mold is desirably a relatively incompressible material. The material of the passage mold can be a thermoplastic material.

The process further can include the step of (partially) filling a press enclosure (or die) 100, the press enclosure 100 being closed with a plug 110, with binder-coated SiC powder 120, as described in step 30 of FIG. 4 and as represented in the cross section of FIG. 5A. Next, the passage mold 130 is placed on/in the SiC powder 120 (FIG. 5B) and an additional amount of SiC powder is put on top of the mold 130, such that the SiC powder 120 surrounds the mold 130 (FIG. 5C, step 30 of FIG. 4). Next, a piston 140 is inserted in the press enclosure 100 and a force AF is applied to compress the powder 120 with the mold 130 inside (FIG. 5D and FIG. 4 step 40) to form a pressed body 150. (Resistance to the force AF (not shown) is supplied at the plug 110 during this step.) Next, with plug 110 now free to move, the pressed body 150 is removed by a (smaller) force AF applied to the piston 140 (FIG. 5E, step 50 of FIG. 4).

Next, the pressed body 150, now free from the press enclosure 100, is machined in selected locations, such as by drilling, to form holes or fluidic ports 160 extending from the outside of the pressed body 150 to the mold 130 (FIG. 5F, step 54 of FIG. 4).

Next, the pressed body 150 is heated, preferably at a relatively high rate, such that the mold 130 is melted and removed from the pressed body 150 by flowing out of the pressed body 150, and/or by being blown and/or sucked out in addition. (FIG. 5G, step 60 of FIG. 4). The heating may be under partial vacuum, if desired.

Finally, the pressed body 150 is fired (sintered) to densify and further solidify the pressed body into a monolithic silicon carbide body 200. (FIG. 5H, step 70 of FIG. 4).

As shown in the flowchart of FIG. 4, additional or alternative steps can include step 72, debinding, step 82, shaping or preliminarily shaping the exterior surface(s), such as by sanding or other machining before sintering, and step 84, finishing the exterior surface(s), such as by grinding, after sintering.

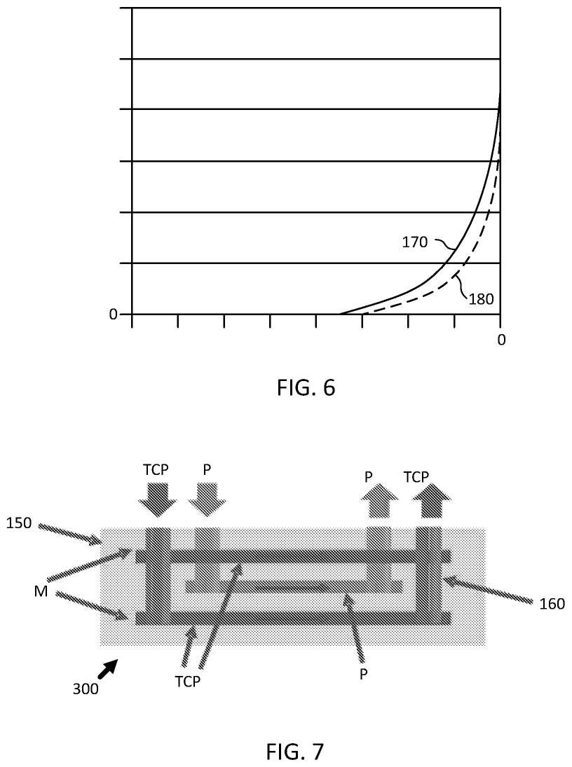

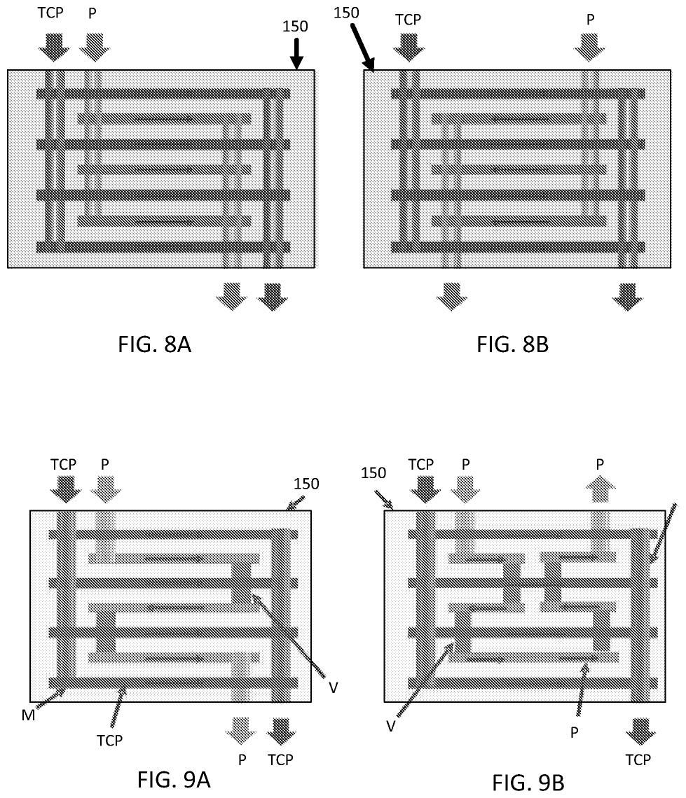

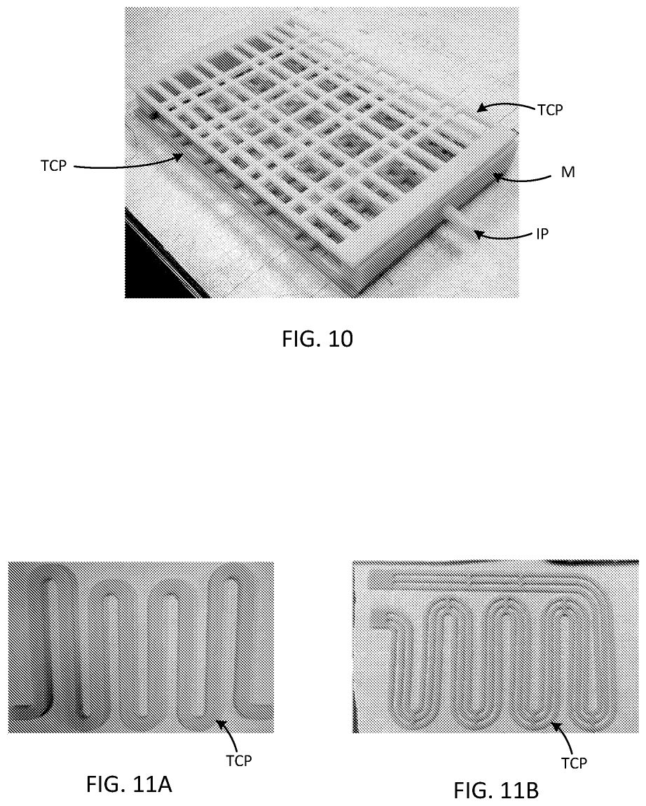

FIG. 6 is a graph illustrating compression release curves useful in practicing the methods of the present disclosure, in particular, showing a desirable relationship between the compression release property of the SiC powder 120 and the passage mold 130. Specifically, a compression release curve 170 of the SiC powder material, graphed in units of distance (x axis) vs force (y axis) (arbitrary units shown) (time evolution is downward and leftward) should preferably lie above a compression release curve 180 of the material of the passage mold 130. The compression curve, not shown, is not particularly significant. But using a relatively incompressible mold material such that the SiC compression release curve 170 lies above the passage mold compression release curve 180 helps maintain the structural integrity of the pressed body during steps subsequent to pressing. Further, to achieve the smooth internal passage walls, coated SiC powder with generally smaller particle sizes is preferred, as are passage mold materials having generally higher hardness.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A silicon carbide flow reactor fluidic module, the module comprising:
a monolithic closed-porosity silicon carbide body;
a tortuous fluid passage extending through the silicon carbide body, the tortuous fluid passage having an interior surface; and
one or more thermal control fluid passages also extending through the silicon carbide body;
the interior surface having a surface roughness of less than 10 μm Ra.

2. The fluidic module of claim 1 wherein the surface roughness is in the range of from 0.1 to 5 μm Ra.

3. The fluidic module of claim 1 wherein the surface roughness is in the range of from 0.1 to 1 μm Ra.

4. The fluidic module of claim 1 wherein the silicon carbide of the silicon carbide body has a density of at least 95% of a theoretical maximum density of silicon carbide.

5. The fluidic module of claim 4 wherein the silicon carbide of the silicon carbide body has a density of at least 96% of the theoretical maximum density of silicon carbide.

6. The fluidic module of claim 4 wherein the silicon carbide of the silicon carbide body has a density of at least 97% of the theoretical maximum density of silicon carbide.

7. The fluidic module of claim 4 wherein the silicon carbide of the silicon carbide body has a density of at least 98% of the theoretical maximum density of silicon carbide.

8. (canceled)

9. The fluidic module of claim 4 wherein the fluidic module has an open porosity of less than 1%.

10. The fluidic module of claim 4 wherein the fluidic module has an open porosity of less than 0.5%.

11. The fluidic module of claim 4 wherein the fluidic module has an open porosity of less than 0.1%.

12. The fluidic module of claim 1 wherein an internal pressure resistance of the fluidic module under pressurized water testing is at least 50 Bar.

13. The fluidic module of claim 1 wherein an internal pressure resistance of the fluidic module under pressurized water testing is at least 100 Bar.

14. The fluidic module of claim 1 wherein an internal pressure resistance of the fluidic module under pressurized water testing is at least 150 Bar.

15. The fluidic module of claim 1 wherein the interior surface of tortuous fluid passage comprises a floor and a ceiling separated by a height h and two opposing sidewalls joining the floor and the ceiling, the sidewalls separated by a width w measured perpendicular to the height h and at a position corresponding to one-half of the height h wherein the height h of the tortuous fluid passage is in the range of from 0.1 to 20 mm.

16. The fluidic module of claim 15 wherein the height h of the tortuous fluid passage is in the range of from 0.2 to 15 mm.

17. The fluidic module of claim 15 wherein the height h of the tortuous fluid passage is in the range of from 0.3 to 12 mm.

18. The fluidic module of claim 15 wherein the interior surface where the sidewalls meet the floor has a radius of curvature in the range of 0.1 to 3 mm.

19. The fluidic module of claim 15 wherein the interior surface where the sidewalls meet the floor has a radius of curvature in the range of from 0.3 mm to 2 mm.

20. The fluidic module of claim 15 wherein the interior surface where the sidewalls meet the floor has a radius of curvature in the range of from 0.6 mm to 1 mm.

21. A process for forming a silicon carbide fluidic module for a flow reactor, the process comprising:
positioning a first layer of silicon carbide powder, the powder coated with a binder;
positioning a first positive fluid passage mold having a tortuous shape on the first layer of silicon carbide powder;
covering the first positive fluid passage mold with a second layer of silicon carbide powder;
positioning a second positive fluid passage mold having a tortuous shape on the second layer of silicon carbide powder, the second positive fluid passage mold not being in contact with the first positive fluid passage mold;
covering the second positive fluid passage mold with a third layer of silicon carbide powder;
pressing the layers of silicon carbide powder with the molds inside to form a pressed body;
heating the pressed body to remove the mold; and
sintering the pressed body to form a monolithic silicon carbide fluidic module having a tortuous fluid passage extending therethrough one or more thermal control fluid passages also extending therethrough.
